(19) United States
(12) Patent Application Publication
(10) Pub. No.: US 2015/0024429 A1
(43) Pub. Date: Jan. 22, 2015

(54) METHOD AND DEVICE FOR THE HOMOGENEOUS DISTRIBUTION OF SUSPENDED CELL COMPONENTS

(71) Applicant: Roche Diagnostics Operations, Inc., Indianapolis, IN (US)

(72) Inventors: Michael Otter, Tucson, AZ (US); Thomas Fischer, Rauenberg (DE); Stefanie Froehner, Penzberg (DE); Phillip Miller, Tucson, AZ (US); Matthew Mette, Marana, AZ (US)

(21) Appl. No.: 14/503,473

(22) Filed: Oct. 1, 2014

Related U.S. Application Data
(63) Continuation of application No. PCT/US2013/035520, filed on Apr. 5, 2013.
(60) Provisional application No. 61/621,107, filed on Apr. 6, 2012.

(51) Int. Cl. G01N 1/31; B05D 1/40; B05C 5/02; G01N 1/30

(52) U.S. Cl. CPC G01N 1/31; G01N 1/30; B05D 1/40; B05C 5/02
USPC 435/40.51; 435/309.1

(57) ABSTRACT

A method for the homogeneous distribution of cell components suspended in a liquid on a surface and a device for the implementation thereof.

### CROSS-REFERENCE TO RELATED APPLICATION

The present application is a continuation of International Application No. PCT/US2013/035520, filed 5 Apr. 2013, which claims priority to U.S. Provisional Patent Application No. 61/621,107, filed 6 Apr. 2012, which is hereby incorporated by reference in its entirety.

### TECHNICAL FIELD

The present disclosure relates to a method for the homogeneous distribution of cell components suspended in a liquid on a surface and a device for the implementation of this method.

### BACKGROUND

The identification and analysis of cells and components thereof, in particular rare cells, is becoming increasingly important in various fields of medical research and diagnosis, such as for example cell biology, oncology, stem cell research, prenatal diagnostics and the like. In this context, both the quantitative and also the qualitative analysis of cells in a biological sample are of particular interest for scientists and medical workers.

A prerequisite for the identification and analysis of individual cells and the components thereof are suitable methods, with which target cells or components thereof in a biological sample such as for example whole blood or other body fluids can be quantitatively detected and then isolated.

A common approach for the separation of the target cells from other cells is by immunomagnetic methods with the use of an antibody towards an antigen which is specific for the target cells. This antibody is coupled to magnetic particles which can then in turn be used to isolate the target from the sample by means of a magnetic field. The technology is used in a multitude of commercial and non-commercial systems. Other approaches use the concept of size exclusion by filtration of sample material (for example, ScreenCell or On-Q-ity). Alternatively, cells can be immobilized on surfaces and then identified as positive cells by immunocytochemistry and/or morphological analysis (e.g., Epic Science). However, these approaches are limited to cell suspensions of low volume.

A disadvantage of the methods described above lies in the high risk of loss of a target cell due to the lack of specificity of the depletion and/or the enrichment. In the case of the immunomagnetic methods, it could for example be that the generally used cell surface antigen EpCAM (Epithelial Cell Adhesion Molecule) is not expressed by a subpopulation of target cells, which would consequently result in a loss during the enrichment process. Similarly, in filtration processes which are based on size differences between non-target cells (usually white blood cells with a diameter of 5-7 μm) and target cells of interest (for example, circulating tumour cells with a diameter of >10 μm), cells of interest which lie at the low end of the size range which is generally observed for target cells are lost. Furthermore, target cells which display no size differences to non-target cells (for example, a malignant subpopulation of white blood cells) might not be isolated by these methods.

Methods which are based on the depletion of cells are only suitable for a relatively small number of cells and therefore do not exhibit the necessary sensitivity. There is therefore a need for alternative methods and devices which are suitable for the identification and analysis of cells and the components thereof, in particular rare cells.

### SUMMARY

It is against the above background that the embodiments of the present disclosure provide certain unobvious advantages and advancements over the prior art. In particular, the inventors have recognized a need for improvements in methods for the homogeneous distribution of cell components suspended in a liquid on a surface, and in devices for the implementation of such methods.

As shown in the examples, at least some embodiments include a method that allows the uniform distribution of cell components suspended in a liquid (cells or components thereof) on a surface. As a result of the method, a uniform distribution of the liquid and of any material suspended in the liquid, and any substances or particles suspended in the liquid on the surface of a carrier object, is available. This material can in particular comprise living or fixed cells (for example of human, animal or plant origin), bacteria, viruses, cell components, proteins, nucleic acids, metabolites or chemicals.

Although the embodiments of the present disclosure are not limited to specific advantages or functionality, it is noted that uniform distribution can be desirable and advantageous for many reasons. Firstly, it can be necessary to detect cell components quantitatively. A uniform distribution is desirable when only a partial analysis of a sample can be undertaken, in order to assess the whole and/or when the individual components are to be separated so that they can be examined individually.

In contrast to the methods known in the art, at least some embodiments of the present disclosure enable the homogeneous distribution of suspended cell components on relatively large surfaces. Such have not hitherto been accessible for cytological or morphological analyses.

In accordance with one embodiment of the present disclosure, a method for the homogeneous distribution of cells or cell components suspended in a liquid on a surface is provided, comprising: positioning a liquid carrier having an upper surface on a table; positioning a distributing bar above the liquid carrier upper surface, a distance from about 50 to about 1000 μm; applying a liquid with cell components suspended therein onto the liquid carrier upper surface; and moving one or more of the distributing bar, liquid carrier, and/or the table in motion to distribute the cell components suspended in the liquid on the liquid carrier upper surface uniformly.

In accordance with another embodiment of the present disclosure, a device for the homogeneous distribution of cell components suspended in a liquid on a surface is provided, the device comprising: a table on which a liquid carrier can be positioned; a liquid application device for applying a liquid onto a liquid carrier positioned on the table, wherein the liquid comprises cell components suspended therein; a distributing bar spaced above and apart from the liquid carrier; and a drive device capable of moving the table, the distributing bar or both individually or simultaneously to move the liquid uniformly across the liquid carrier surface.

These and other features and advantages of the embodiments of the present disclosure will be more fully understood from the following description in combination with the drawings and the accompanying claims. It is noted that the scope of the claims is defined by the recitations therein and not by the specific discussion of features and advantages set forth in the present description.

### BRIEF DESCRIPTION OF THE DRAWINGS

The following detailed description of the embodiments of the present disclosure can be best understood when read in conjunction with the following drawings, where like structure is indicated with like reference numerals and in which:

FIG. 1 is a top view of a device according to the disclosure according to a first embodiment;

FIG. 2 is a side view of a device according to the disclosure according to a first embodiment;

FIG. 3 is a perspective view of a device according to the disclosure according to a second embodiment;

FIG. 4 is a top view of a device according to the disclosure according to a second embodiment;

FIG. 5 is a side view of a device according to the disclosure according to a second embodiment;

FIG. 6 is a perspective representation of a distributing bar and some possible cross-sections of the distributing bar represented adjacent to this;

FIG. 7 is a perspective view of a diagrammatically represented distributing bar with internal structures; and

FIG. 8 is a perspective view of a device according to the disclosure according to a third embodiment.

Skilled artisans appreciate that elements in the figures are illustrated for simplicity and clarity and have not necessarily been drawn to scale. For example, the dimensions of some of the elements in the figures may be exaggerated relative to other elements to help improve understanding of the embodiment(s) of the present disclosure.

### DETAILED DESCRIPTION

The method provides for the homogeneous distribution of cell components suspended in a liquid on a surface. Homogeneity designates the uniformity of a property over the whole extent of a system. However, the uniform distribution of suspended components in the liquid is difficult inasmuch as the suspended components are susceptible to sedimentation and phase separation.

Consequently, homogeneous distribution means the uniform distribution of the cell components on the surface of the liquid carrier. A uniform distribution of the cell components can also be characterized as a relatively constant area density of the cell components over the surface. Here the area density can be understood as the number of the cell components per unit area, for example the number per cm². If an equal number of cell components are counted in every area unit examined, then this will be described as a homogeneous distribution. Herein, it is expected that the number of cell components per cm² will rather correspond to a normally distributed random value. A deviation from a constant number per cm² is therefore tolerable in a usual statistical range.

In a first step of the embodiment, a liquid carrier is placed on a table. By table it is meant any means which is suitable for accommodation of the liquid carrier. As a rule it will be a means with a surface on which the liquid carrier can be placed horizontally. For this, the table can in particular include a planar surface. In addition, the table can be suitable for facilitating access to the liquid carrier. For this, the table can, for example, have raised parts, such as a central platform and/or a knob field on a planar surface, in order to bring the liquid carrier to an elevated, exposed position, and/or depressions, such as access openings and/or channels in a planar surface, in order to be able to easily grasp the liquid carrier from below. In addition, the table can contain further components which are suitable for the implementation of the method, for example, means for immobilizing or releasably retaining the liquid carrier can be present. The table can be coupled to a drive device which is suitable for moving the table, such as, for example, to a linear mover or a drive shaft for rotation of the table.

It has surprisingly now been found that a homogeneous distribution of cell components suspended in a liquid can be achieved by means of a method wherein a distributing bar is moved at a defined distance above the liquid carrier.

Hence, in a further step, a distributing bar is placed above the liquid carrier, the distance between the distributing bar and the liquid carrier being between 50 and 1000 μm, or between 350 and 1000 μm. Under the precondition that sufficient liquid is present on the liquid carrier, so that adhesion of the liquid on the distributing bar occurs, it was observed that during the motion of the distributing bar the cell components distribute themselves uniformly on the surface. It is assumed that through the adhesion of the liquid to the bar during the movement of the bar relative to the surface, flows and turbulences occur in the liquid region between bar and surface, which hold the suspended cell components in the solution and thus enable their uniform distribution.

In a further step of the process, according to an embodiment, the liquid and cell components suspended therein are applied onto the liquid carrier. The step of applying the liquid and the step of positioning the distributing bar can be performed successively in any order or else simultaneously, whichever is appropriate. The application of the liquid can be effected via an applicator, such as a pipette mounted on the table and/or on a liquid applicator in the distributing bar. The liquid can also be fed into the distributing bar via channels and can be then be poured on, sprayed on, dripped on or otherwise distributed.

According to the teaching of at least some embodiments of the disclosure, it does not matter how high the liquid level is applied on the liquid carrier. That is to say that in one embodiment the distributing bar may be completely immersed in the liquid and in another embodiment the distributing bar may be only partly immersed in the liquid. However, at least partial immersion of the bar in the liquid is a precondition for the cell components to be moved in the liquid via the flows created by the relative movement between the distributing bar and the liquid carrier. In one embodiment, the distributing bar is configured so the liquid on the liquid carrier adheres to the section in contact with the liquid. In one embodiment, the distributing bar is convex. The convexity relates to the transverse profile of the distributing bar, that is, expressed as a negative feature, that no distributing rods are proposed which are shaped concave in a forward direction, for example, snow plough-like devices with shovel blades.

In at least some embodiments of the present disclosure, cell components are suspended in a liquid. A suspension is understood to mean a heterogeneous substance mixture of a liquid and solids distributed therein which are held in suspension. Such a suspension is a coarse dispersion of cells or cell components and has a tendency to sedimentate or phase separate. If a suspension is allowed to stand, then (in contrast to a solution) if the particle size is not too small the solid slowly sinks to the bottom as sediment (sedimentation). The stability of a suspension can be defined with a sedigraph, which measures the sinking rate of different particles according to the Stokes law. The smaller a particle, the lower its density and the higher the viscosity of the liquid are, the more slowly the sedimentation proceeds. The shape and structure of the particles and other properties of particles and liquid also influence the sedimentation. The sedimentation can be accelerated by centrifugation.

In the sense of the present disclosure, cell components is understood to mean both cellular components, i.e., parts of cells such as intracellular components, cell membranes or walls or else components thereof, as well as whole cells, intact or no longer intact.

The cell can be any cell whatsoever, such as a plant, animal (including human), bacterial or fungal cell. Consequently, the cell can be prokaryotic or eukaryotic and derive from a single-celled or multicellular organism. The size of cells varies greatly. The cell can have a diameter between about 0.2 μm and about 200 μm, between about 0.5 μm and about 100 μm, or between about 1 and about 30 μm.

As mentioned above, the cell can be a prokaryotic cell. The prokaryotes include the bacteria and the archaeae. Alternatively it can be a eukaryotic cell. The eukaryotic cells include animal (including human) cells, plant cells and fungal cells, which differ in their structure. Typically, a eukaryotic animal cell, inter alia, includes the following components: cell nucleus, mitochondria, Golgi apparatus, endoplasmic reticulum, ribosomes, vesicles, lysosome, cell membrane, cytoplasm and centrioles. Plant cells as a rule possess in addition a cell wall and chloroplasts or other plastids and vacuoles. Fungal cells also possess a cell wall, but of chitin.

Cell components can thus be the cell components mentioned above. Further, the cell component can also be an infectious particle which can reproduce itself within a suitable host cell (intracellularly). Examples of this are viruses or structures derived therefrom (artificially created or else naturally occurring) such as virus-like particles, virions, capsid variants, etc.

Further, the component of cells can also be any other component of the cell or of components thereof mentioned above, as long as this is not soluble in the liquid. For example, it can be a component of the cytoplasm or the cell membrane, such as, for example, proteins, lipids, polysaccharides, nucleic acids, (small) organic molecules or glycoproteins.

In one embodiment, the cell components are cells. The cells can for example be intact, no longer intact, living, dead, naturally occurring or artificially created cells, where these contain the typical cell components. As stated, the cells can also be dead; this can, for example, have happened as a result of purification or else fixing.

The cells can be any cell whatsoever; however, a single (also separated) cell is often the most useful, hereinafter referred to as a single cell. Here the cell is not or no longer in a fixed cell association of a large number or multitude of cells. The single cell can occur naturally, such as, for example, cells of single-cell organisms or cells, which are naturally not in a cell association, such as a cell transported in the blood (e.g., blood cells, stem cells, circulating cells, metastasizing cells, circulating DNA, etc.) sperms, ova or spores. Alternatively, the cell can also be isolated (separated) from a cell association. Methods for the separation of cells are known to those skilled in the art and can for example be enzymatic digestion (for example with trypsin, hyaluronidase, or the like) or application of shear forces.

Cytology samples, such as fine needle aspirations, are typically applied to a microscope slide by method of dispensing the sampled cells together with a small amount of tissue fluid. The formed droplet from such aspirates is then typically smeared onto a larger surface area using another microscope slide, cover slip, or with the needle itself. The cells must be thinly and delicately smeared with minimal cellular distortion and for best presentation, but the smear layer can't be applied too thinly or with excessive shear force to avoid cell damage. Blood smears, such as for the investigation of hematological problems are prepared in a similar fashion, where a small amount of the blood specimen is placed with a pipette needle or transfer pipette onto a microscope slide, and then also smeared through the use of a spreading device such as another microscope slide, or coverslip glass typically held at a slight angle (wedge technique) and with minimal force.

Pap test sampling is typically obtained by using a spatula, cotton swap, or brush. The specimen is then placed into a special liquid preservative. The resulting cell suspension is then either filtered or spun down and transferred to a microscope slide for thin layer preparation, often resulting in cell loss and/or damages. In more conventional Pap smear tests, the specimen may be transferred directly to the microscope slide with the sampling device, thereby producing irregular and thick layers that are often clouded by debris such as from blood and mucus which may obscure cell visibility.

Where the disclosed method is used for producing cell smears from cytology fine needle aspirations and Pap test samples onto microscope slides, a suspension of cells in an intermediate liquid layer is distributed by the herein described method onto a reaction surface.

For hematology blood samples a thin layer of blood smear can be produced by the described method onto a reaction surface. Alternatively, the blood sample can be immersed into a stabilization liquid, anticoagulant, or lysing buffer, and the cell suspension then directly transferred to a reaction surface and distributed utilizing the described method.

Before use in the method according to one or more embodiments of the present disclosure, the individual cells can also be purified, for example by centrifugation methods, differential cell culture or flow cytometry (such as FACS (fluorescence activated cell sorting)).

The liquid wherein cell components are suspended can be any liquid whatsoever, which is suitable for the suspension of the cell components. If necessary, the liquid should be suitable to maintain the integrity and unimpaired functioning of the cell components. In particular, in the case of intact cells it can be desirable to maintain the viability of the cells. With proteins it can be necessary to select a liquid which maintains the tertiary and quaternary structure of the protein.

In the state of the art, a large number of liquids which fulfil these preconditions are known. As a rule these are liquids based on water, and suitable additives such as buffers, nutrients, growth factors, salts, etc. may be dissolved in the water. Such media are well known to those skilled in the art and are obtainable from a range of commercial suppliers.

The liquid can have a higher viscosity than water in order to slow sedimentation of the cell components. In particular, the viscosity can be >2 mPas, in the range from 2 mPas to 1000 mPas, or in the range from 10 mPas to 100 mPas. To increase the viscosity of a liquid which is based on water, any polar solvent with a viscosity higher than that of water can be added, in particular water-soluble polymer and/or oligomer solutions.

According to a further step of the method, in accordance with an embodiment of the present disclosure, for the distribution of the cell components suspended in the liquid on the liquid carrier, the distributing bar and/or the table are set in motion. Here the table can be immobile with movement of the distributing bar, or the table can itself be moved. In the case where the table moves, the distributing bar can be immobile or can itself be moved, even in a direction contrary to the motion of the table. With linear motion the table can be moved, with an immobile distributing bar, or the distributing bar can be moved, with an immobile table. With rotational motion, the table can be rotated while the distributing bar remains immobile or the distributing bar can be rotated while the table is immobile. The relative motion between the table and the distributing bar requires very precise control, so that the distance between the distributing bar and the liquid carrier, which can be fixed on the table, remains as constant as possible. A distance of between 50 and 1000 μm, or between 350 and 1000 μm, between the distributing bar and the liquid carrier is generally helpful for implementation of the present embodiment. Regardless of the distance it should be maintained during the motion to achieve a consistent distribution of cell components. With motion between the liquid carrier and the distributing bar at the chosen distance, the effect of a homogeneous distribution of the cell components on the liquid carrier takes place.

In one embodiment, the cell components are separated and assembled in a quasi-monolayer fashion. Separation means that one cell component has no contact with another and in the ideal case is an adequate distance therefrom. This allows individual examination of each cell component of the suspension, which can be of advantage, for example in the identification of rare cells and their subsequent examination.

In one embodiment of the present disclosure, the method can further comprise at least one of the following steps: aspiration of the liquid after a sufficiently homogeneous distribution has been achieved, and/or; drying of the liquid carrier with the cell components located thereon; and application of additional fluidic step(s) after drying, such as for fixation or staining purposes of dried cells.

The method can comprise both aspiration and drying, and also both steps can be performed one after the other or else simultaneously. Instead of the aspiration, any method can be used which removes the liquid from the liquid carrier, for example, drying, vaporization, allowing to evaporate, skimming, allowing to drain away, allowing to run out or allowing to drip out. The drying of the cell components homogeneously distributed on the liquid carrier that follows or is associated therewith can serve for the preservation and/or the provision of the cell components for further purposes, in particular for the identification and analysis of individual cells and the components thereof.

Cell components suspended in the liquid generally will include at least one subgroup which is to be detected.

As already mentioned above, this can be a subpopulation of cells. As also already mentioned above, the present disclosure is particularly suitable for the identification and analysis of cells and components thereof, in particular rare cells, since the homogeneous separation of the cell components on a surface facilitates specific identification and analysis.

Generally it is most appropriate that the cell components be cells. Examples of such cells are: cancer cells such as, for example, circulating tumour cells or circulating DNA or tumour microemboli, or certain blood cells, such as, for example, B cells, T cells, eosinophils, etc.

In other embodiments the target cells are rare cells, in particular where the proportion of rare cells to the total cells is at most 1%, in particular at most 0.1%, e.g., at most 0.01%. Rare cells can be circulating tumour cells (CTC) or circulating tumour micro-emboli (CTM) in the blood of patients.

The technical challenge is to find and identify the rare tumour cells (only a few CTCs are contained in 1 ml of blood with about 10 million leucocytes and 5 billion erythrocytes). However, this is of great importance diagnostically and therapeutically, since these cells are detectable long before the tumour itself. The earlier detection enables an earlier therapeutic approach, which will as a rule be associated with fewer side effects and better chances of a cure.

Of course it can also be a target cell or a component thereof which is indicative for another condition, in particular for another disease.

In one embodiment, the surface of the liquid carrier is at least 100 cm² in size or between 100 cm² and 1000 cm² in size. The surface of the liquid carrier can have the size of a CD or a record (LP). The normal commercial CD has a diameter of 120 mm or a diameter of 88 mm and a central hole with a diameter of 15 mm. The record has a diameter of 7 in., i.e., 177.8 mm, and a central hole of size 1.5″, i.e., 38.1 mm. Such sizes for the liquid carrier have the advantage that they are particularly easily manipulatable. Under some circumstances they can be produced particularly cheaply since in principle plants for CD production or for LP production can be used, and these would have to be modified only slightly or not at all. In a particularly advantageous embodiment, it is possible even to use conventional CDs or LPs as liquid carriers, which are mass-produced goods which allow inexpensive production.

A further aspect of the present disclosure is a device for the implementation of the method according to one or more embodiments of the present disclosure, which comprises a table on which a liquid carrier can be positioned, a distributing bar, and a drive installation for the table and/or the distributing bar.

In other embodiments the use of single or multiple microscope slides as the liquid carrier is envisioned.

In such an embodiment, the table and/or the liquid carrier are made rectangular in cross-section. The surface of the rectangular liquid carrier can be made in the size of one or more adjacently laid microscope slides of any size. The size can also have an area value of about the size of a CD, i.e., of about 111.33 cm², is reached, for example by an area of 78 mm×152 mm, i.e., twice two microscope slides or by an area of 104 mm×152 mm, i.e., four times two microscope slides or by an area of 104 mm×76 mm, i.e., four times one microscope slide. Alternatively to this, an area of the size of an LP, i.e., of a record, can be selected, where here the area can be reached by various arrangements of about 30 microscope slides of the size 26 mm×76 mm, yielding a rectangle.

In an alternative embodiment, the table and/or the liquid carrier are made circular in cross-section. Here, the liquid carrier can have a hole in the middle for manipulation by a machine or a user. As normal with CDs, in this way keeping and storage of unused liquid carriers and even of liquid carriers with dried cell components can be effected in a spindle, i.e., in a so-called cakebox, wherein they can be laid above one another, saving space.

It is also preferable that in this device the longitudinal axis of the distributing bar encloses an angle of 0° with the table, so that the distance between the distributing bar and the table is constant over the length of the distributing bar. Alternatively to this, however, it can also be specified to provide an angle between 0° and 15° or an angle between >0° and <5°, the distance between the distributing bar and the table in the middle of the table being smaller than at the edge of the table. Thereby the effect can be achieved that the cell components are pushed further to the edge of the liquid carrier during the motion.

In another embodiment of the present disclosure, the distributing bar and/or the liquid carrier can possess positioning elements for maintenance of the defined distance during the motion. As already described above, the distance according to the present disclosure of between 50 and 1000 μm, or between 350 and 1000 μm, between the distributing bar and the liquid carrier, is essential for the embodiments of the present disclosure and must be maintained during the motion. Since in general the distributing bar is movably mounted on a support structure and/or the support structure with the distributing bar fixed thereon is positioned movably relative to the table, in the course of time existing manufacturing tolerances can be exceeded owing to material fatigue, so that the distances between the distributing bar and the liquid carrier stipulated according to the embodiments of the present disclosure are not maintained. This can be counteracted through the use of positioning elements. In one embodiment, the positioning elements can be provided at the edge of the liquid carrier in the nature of an outer wall. Thereby at the same time an outer boundary element for the liquid carrier is created, which prevents the liquid and/or the cell components suspended therein from being able to leave the liquid carrier. In the event that the liquid carrier has a hole in the middle, positioning elements can be provided both at the outer edge of the liquid carrier and also in the middle thereof bounding the hole, so that the liquid and/or the cell components suspended therein do not leave the liquid carrier. In further embodiments of the present disclosure, the liquid in which the cell components are suspended is viscous such that it does not leave the liquid carrier during the motion.

In one embodiment, the device has an applicator pipette. By means of the applicator pipette, the liquid which contains cell components can be applied onto the liquid carrier specifically, i.e., point by point. The applicator pipette can be coupled onto the distributing bar and movably supported on the distributing bar, for example via a rail guide or a clamp guide, i.e., a clamp movably located on the distributing bar which has a holder for the applicator pipette.

The device can also be made with no applicator pipette, i.e., in this case so that the liquid with the cell components is fed into the liquid carrier via an external feed or supply device, which itself does not have to be part of the device according to the embodiments of this disclosure. The external feed device can be coupled to outlets of the distributing bar via feed/supply pipe(s) or tube(s). Alternatively to this, the device can also be made such that the liquid has to be applied onto the liquid carrier manually by an employee. The applicator pipette can also be separated from the distributing bar.

In one embodiment, the surface of the liquid carrier possesses a coating with antibodies and/or with lipophilic molecules and/or is at least partially electrostatically charged and/or the liquid carrier consists of a material which is polycarbonate, polymethyl methacrylate or glass. The intent of such a coating or surface treatment being to assist in the adherence or retention of the cells/cellular components to the liquid carrier upper surface.

In the field of cell biology, a large number of materials can be used. In principle, these are suitable in the present method and the present device. Common materials are plastics such as polyethylene terephthalate, polycarbonate, polystyrene and polymethyl methacrylate and glass such as borosilicate glass. Further, surfaces can be of gold, titanium dioxide, zirconium, etc. In addition, these surfaces may be physically or chemically modified, e.g., by protein coating with collagen type I, poly-D-lysine, poly-L-lysine, fibronectin or laminin. Also possible are functionalized surfaces such as for example those with a coating with antibodies, streptavidin or lipophilic molecules. The purpose of this is the control of the adhesion of the cell components, either through nonspecific improvement of the adhesion or through improvement of the adhesion for certain species (e.g., by functionalization by means of antibodies).

The drying process can be accomplished by sufficient time, possibly up to several hours for air drying or less if heated or circulating air is used to dry the applied fluid layer containing the cells of interest. During this time the cells will settle and bind to the charged surface of a standard microscope slides. These slides are typically provided with a permanent positive charge that electrostatically attracts cell preparations or cytology samples, binding them to the slide and forming a bridge that ionically bonds the cell preparations to the glass. This drying process can also be performed on previously fixed cells. The drying process can be further accelerated by heating the slides (e.g., positioning slides onto a heated surface) of ˜37° C.

In order that the embodiments of the disclosure may be more readily understood, reference is made to the following examples, which are intended to illustrate the invention, but not limit the scope thereof.

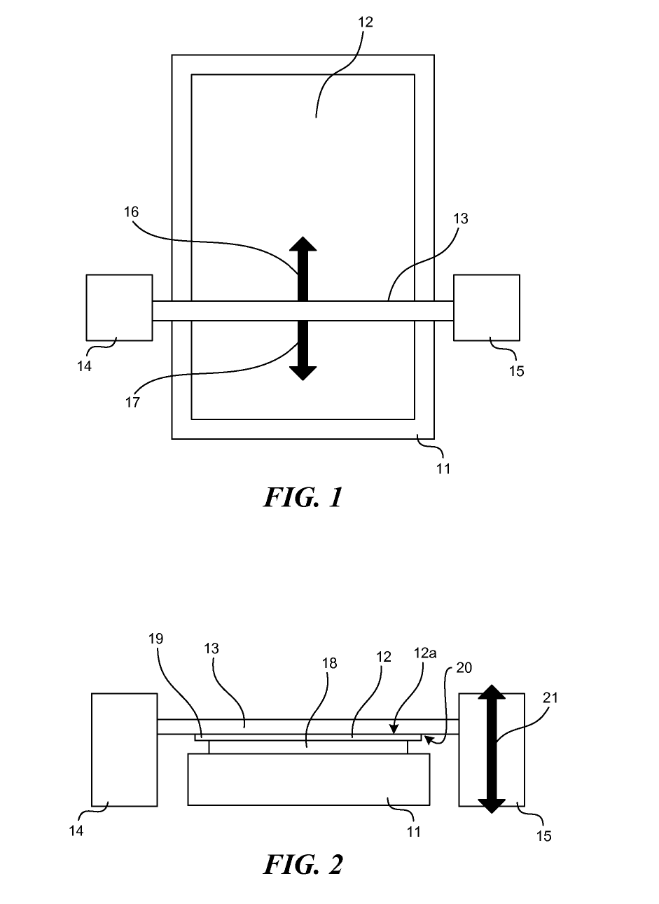

FIG. 1 shows a top view of a device according to an embodiment of the disclosure. On a table 11 is positioned a liquid carrier 12, having and upper surface 12a on which a liquid which contains cell components is or can be deposited. The area of the table 11 is somewhat greater than that of the liquid carrier 12, so that the liquid carrier 12 can lie on it completely. Further, a distributing bar 13 is illustrated which in the illustration is fixed at both ends by two support structures 14 and 15. The support structures 14 and 15 can be mutually independent components, but can also be coupled together. In addition, the support structures 14 and 15 can be coupled to a drive, so that they can be moved simultaneously along one side of the table 11, which is represented in FIG. 1 by arrows indicating the directions of motion 16 and 17 or separately.

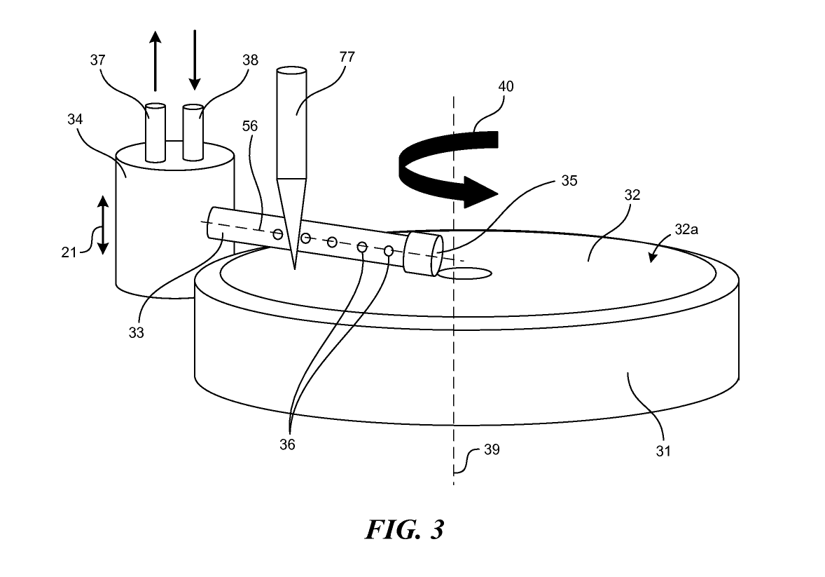

FIG. 2 shows a side view of the first embodiment of the device according to the disclosure shown in FIG. 1. According to this embodiment, the table 11 has a centrally positioned platform 18, on which the liquid carrier 12 is positioned. The platform 18 has an area which is somewhat smaller than that of the liquid carrier 12. This has the advantage that a user of the device can easily detach the liquid carrier 12 from the table 11 by grasping from below a projection 19 which is formed by the overhang of the liquid carrier 12 over the platform 18. The table 11 may also comprise retainers that releasable retain the liquid carrier 12. Also shown is that the support structures 14 and 15 can be adjustable in height, i.e., are made electrically and/or mechanically drivable, so that a distance 20 of the distributing bar 13 from the liquid carrier surface 12a and from the table 11 can be set, as is represented in FIG. 2 by an arrow indicating the direction of motion 21.

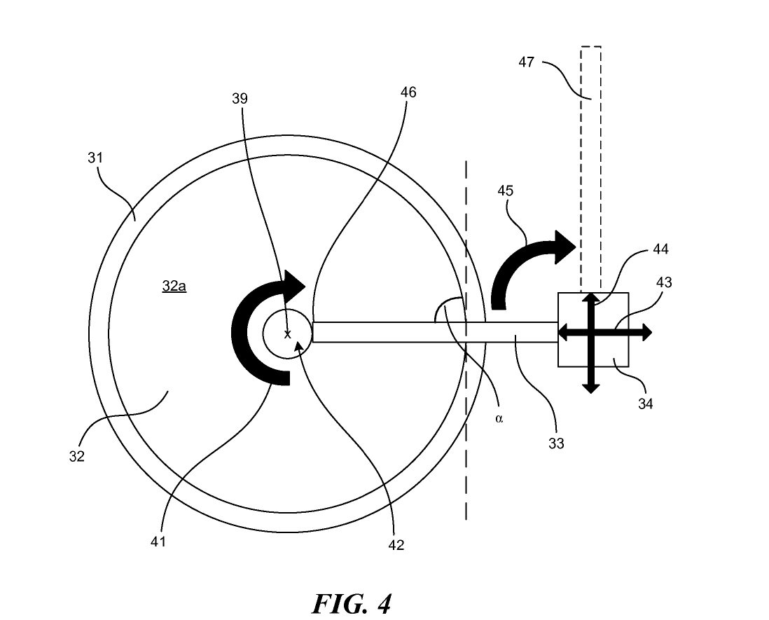

FIG. 3 shows a perspective view of a device according to another embodiment of the disclosure. On a table 31 is positioned a liquid carrier 32, having an upper surface 32a on which a liquid which contains cell components can be deposited. In addition, a distributing bar 33 is illustrated, which is mounted on a support structure 34, the longitudinal axis thereof 56 at least partially extends over an area of the liquid carrier 32. The distributing bar 33 is height-adjustably mounted on the support structure 34, which in this example with reference to FIG. 2, is represented by the reference symbol 21. In addition, the distributing bar 33 has several, here for example five, inlets and/or outlets 36, which can be distributed over its longitudinal axis 56. The inlets and/or outlets 36 are connectable to pipes, as is explained in more detail with reference to FIG. 7. In the practical example shown in FIG. 3, the inlets and/or outlets 36 are coupled to a vacuum pipe 37 and to a feed pipe 38, which are part of the support structure 34.

Also shown is an applicator pipette 77, which according to the practical example shown is coupled to the distributing bar 33. The liquid which contains cell components will be applied specifically onto the liquid carrier upper surface 32a via the applicator pipette 77. The applicator pipette 77 can be mounted movably relative to the distributing bar 33, for example via a rail guide, which is not shown.

The distributing bar 33 is supported on the liquid carrier surface 32a by means of a positioning element 35. The positioning element 35 can be advantageously mounted relative to the distributing bar 33 such that it can be rotated about the distributing bar 33, as a result of which it can roll like a castor on the liquid carrier upper surface 32a. The positioning element 35 is between 50 and 1000 μm, or between 350 and 1000 μm high, so as to set the distance between the distributing bar 33 and the liquid carrier upper surface 32a according to the disclosure.

In the practical example shown, the table 31 is made movable relative to the distributing bar 33 and rotatable about a main axis 39 which is made vertical to the surface of the table 31 on which the liquid carrier 32 is positioned. Such a rotatory motion 40 is shown by an arrow in FIG. 3. Through the rotation of the table 31, motion of the table 31 relative to the distributing bar 33 takes place, so that the distributing bar 33 is in contact with the liquid on the liquid carrier upper surface 32a and during the motion creates turbulent and laminar flows in the liquid, which results in swirling of the cell components in the liquid, as a result of which the homogeneous distribution of the cell components in the liquid is attained. In a modification of the device, not shown, the table 31 can be positioned fixed in space and the support structure 34 with the distributing bar 33 mounted thereon can rotate around the table 31, so that the uniform distribution of the liquid and the cell components contained thereon on the liquid carrier surface 32a likewise takes place.

FIG. 4 shows the second embodiment of the device according to the disclosure with the circular table 31 and the circular liquid carrier 32 in top view. In the embodiment shown, the table 31 with the liquid carrier 32 positioned thereon rotates about its main axis 39, as is indicated by an arrow 41. The distributing bar 33 extends approximately over one half diameter of the liquid carrier 32 from its edge to the middle. At its middle, the liquid carrier 32 has a hole 42 for manipulation by a mechanical gripping arm or a user.

The distributing bar 33 is mounted freely swivelling on a support structure 34 with a single support, which can be moved in the plane of the liquid carrier 32 in two directions of motion 43 and 44 mutually independently, as is shown by arrows. Thus tracking of the support structure 34 with the distributing bar 33 mounted thereon is possible. The distributing bar 33 can be tracked away from the table 31 in one of the directions of motion 43 and 44 shown, so that access to the liquid carrier upper surface 32a is possible without hindrance.

In addition, the support can be rotatable, so that a rotation of the distributing bar 33 about one of its ends, as shown by an arrow 45, is possible. In this embodiment, the structure of the device according to the disclosure is similar to that of a record player which can place a needle on the record and remove the needle from the record again, where the needle might be imagined approximately as being at the free end of the distributing bar 33. Hence the distributing bar 33 is transferable to a resting position 47, which is shown FIG. 4 by dotted lines. In the resting position 47, for example, unimpeded access to the liquid carrier 32 can take place.

In case of need, the distributing bar can also be positioned not as shown with its tip 46 in the middle of the liquid carrier 32, but with its tip 46 at any position on the liquid carrier upper surface 32a and the angle a between the edge of the liquid carrier 32 and the distributing bar 33 can also be selected other than 90°. In this case, the rotation of the liquid carrier 32, during which the liquid is in adhesion with the distributing bar 33, ensures that the liquid is moved towards the edge of the liquid carrier 32 or in direction towards its middle, depending on the direction of rotation. In the event that an applicator pipette initially distributes the liquid in the middle of the liquid carrier upper surface 32a, it can be advantageous to set the angle α less than 90° and nonetheless to extend the distributing bar 33 over the length of one radius of the liquid carrier upper surface 32a so that for example a liquid and cell components suspended therein, the distribution whereof after application onto the liquid carrier exhibits a maximum in the middle of the liquid carrier are pushed more strongly in the direction of the edge by the motion and are thereby homogeneously distributed.

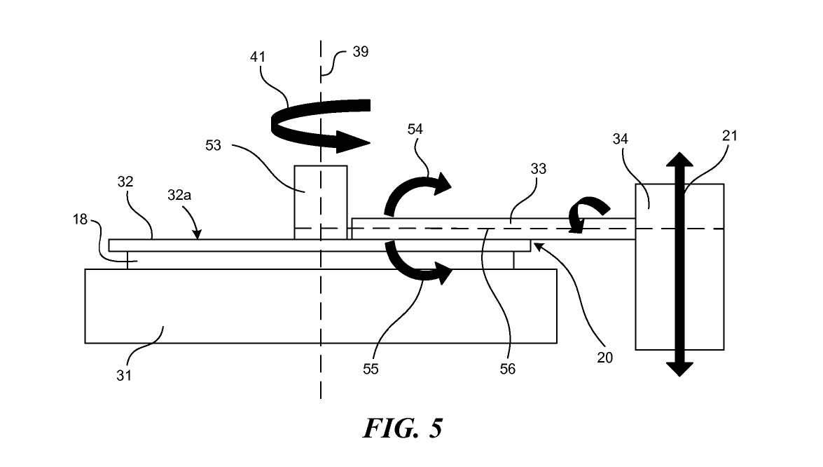

In FIG. 5, a side view of the device according to the practical example according to FIG. 4 and FIG. 3 is shown. In its middle, the table 31 has a platform 18 which serves for better manipulation of the liquid carrier 32. The distance 20 according to the disclosure is set between the distributing bar 33 and the liquid carrier upper surface 32a. The distributing bar 33 is mounted on the height-adjustable support 34, the height adjustability again being indicated by an arrow 21. A further arrow 41 indicates that the table 31 is rotatable about its main axis 39. In this embodiment, the table 31 has a spindle 53 in the middle, by which the liquid carrier 32 is held. The spindle 53 enables very precise positioning of the liquid carrier 32 on the surface of the table 31. Two further arrows 54 and 55 indicate that the distributing bar 33 can also be mounted on the support 14 swivellable about its longitudinal axis 56. Thereby an angle between the distributing bar 33 and the liquid carrier 32 can be set so that the distance between the distributing bar 33 and the liquid carrier upper surface 32a can be variably set over the radius of the liquid carrier 32.

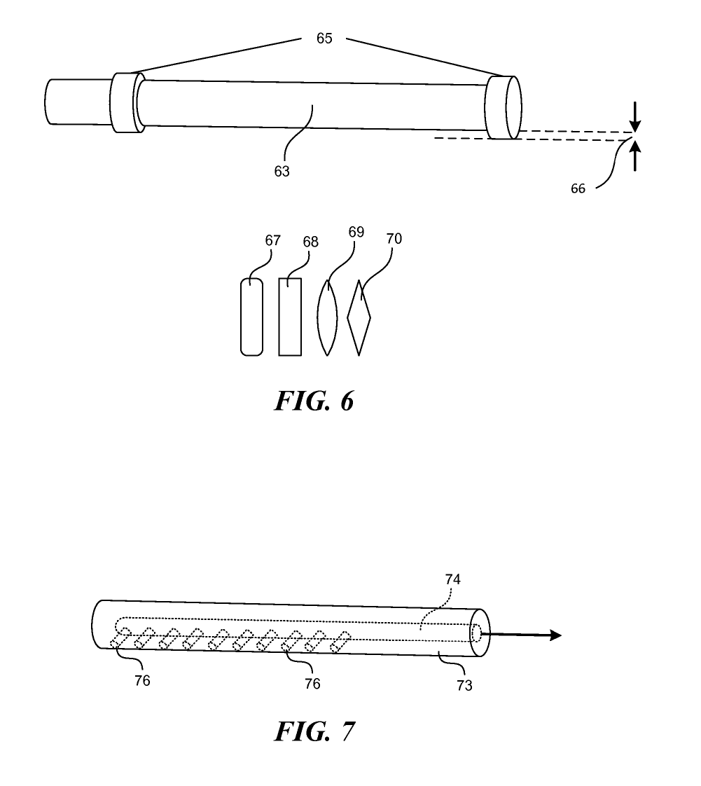

The distributing bar 63 in FIG. 6 has two positioning elements 65, which have a height differential 66, of between 50 and 1000 μm, or between 350 and 1000 μm, in order to ensure the distance according to the disclosure between the distributing bar 63 and a liquid carrier. In addition, various embodiments of cross-sections of the distributing bar 63 are shown. In a first embodiment, a cross-section in the form of a rounded rectangle 67 is provided, wherein the shorter side of the rectangle can be turned towards the liquid carrier in the constructed device. In an alternative embodiment, the cross-section of the distributing bar 63 can be made rectangular, as indicated by the reference symbol 68. In a further embodiment, a cross-section in the form of a convex lens can be provided, for example biconvex, as indicated by the reference symbol 69. According to a further embodiment, which is indicated by the reference symbol 70, a diamond-shaped cross-section of the distributing bar 63 can also be provided. Convexity is common to all embodiments. In these, the convex surface is always turned in the direction of forward motion towards the liquid. Also possible are plane-convex cross-section areas or areas in the form of concave-convex lenses, where with the last two embodiments, a direction of motion of the distributing bar 63 over the liquid carrier is provided such that the concave shaped area always faces in the direction of the forward motion.

FIG. 7 shows an internal view of a distributing rod 73 which has a central channel 74 which can be connected to a vacuum pump and/or to a liquid tank, and which has a plurality of outlets and/or inlets 76 which are connected to the internal channel 74. Alternatively, several channels 74 with one or more of the said functions can be provided in the distributing bar 73.

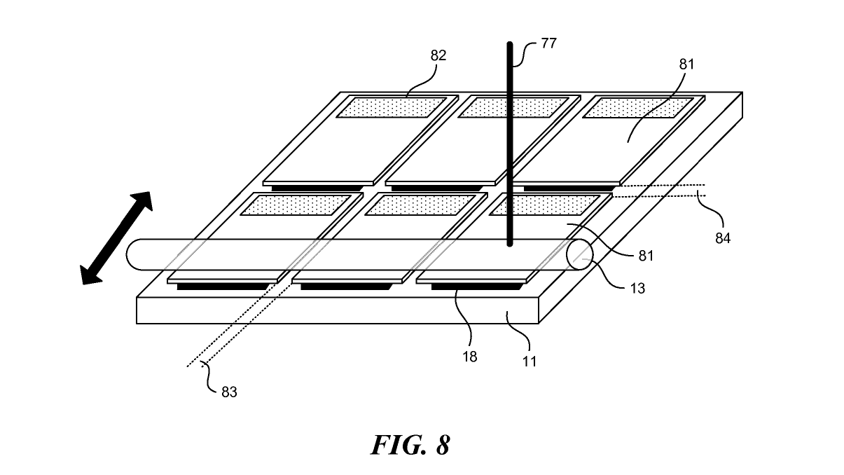

FIG. 8 shows a perspective view of the device according to another embodiment of the disclosure. On a table 11 are positioned a multitude of platforms 18, on which the liquid carrier(s) 81 is(are) positioned. The platform 18 has an area which is somewhat smaller than that of the liquid carrier 81, thus containing the fluid by surface tension due to the surrounding air barriers. Adjacent liquid carriers 81, for example microscope slides, are separated by a large enough gap 83 and 84 to contain fluid aliquots on the individual carriers 81 without fluidic bridging to adjacent carriers. The distribution bar 13 is in contact with the liquid on the liquid carrier upper surface(s) 81a and during the motion creates turbulent and laminar flows in the liquid, which results in swirling of the cell components in the liquid, as a result of which the homogeneous distribution of the cell components in the liquid is attained.

Also shown is an applicator pipette 77, which according to the practical example shown is coupled to the distributing bar 13. The liquid which contains cell components will be applied specifically onto the liquid carrier upper surface(s) 81a via the applicator pipette 77. The applicator pipette 77 can be mounted movably relative to the distributing bar 33, for example via a rail guide, which is not shown. Alternatively the applicator pipette can be separated from the distribution bar 13.

Each of the liquid carriers 81 has a unique identification area 82, which allows referencing of the applied samples to individual carries or a set of carriers. Identification means may be through pre-printed labels, barcodes, manually created information, or other electronic means.

It is noted that terms like “preferably”, “commonly”, and “typically” are not utilized herein to limit the scope of the claimed subject matter or to imply that certain features are critical, essential, or even important to the structure or function of the embodiments disclosed herein. Rather, these terms are merely intended to highlight alternative or additional features that may or may not be utilized in a particular embodiment of the present disclosure.

It is noted that the terms “substantially” and “about” are utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modifications and variations come within the scope of the appended claims and their equivalents.

What is claimed is:

1. A method for the homogeneous distribution of cell components suspended in a liquid on a surface, comprising:
a. positioning a liquid carrier having an upper surface on a table;
b. positioning a distributing bar above the liquid carrier upper surface a distance from about 50 μm to about 1000 μm;
c. applying a liquid comprising cell components suspended therein onto the liquid carrier upper surface; and
d. moving one or more of the distributing bar, the table, and liquid carrier to distribute the cell components suspended in the liquid on the liquid carrier upper surface uniformly.

2. The method of claim 1, wherein the liquid sufficiently adheres to the distributing bar to enable the movement and distribution of the liquid uniformly on the liquid carrier upper surface.

3. The method of claim 1, wherein the cell components within the liquid are separated.

4. The method of claim 1, wherein the cell components within the liquid comprise cytology fine needle aspiration, Pap test or circulating tumour cell components.

5. The method of claim 1, wherein the distance is from about 350 μm to about 1000 μm.

6. The method of claim 1, wherein the liquid carrier upper surface comprises a coating or other cell retaining property.

7. The method of claim 6, wherein the surface of the liquid carrier positioned on the table has an at least partly electrostatically charged surface or a coating of one or more antibodies and/or lipophilic molecules thereon.

8. The method of claim 1, further comprising at least one of the steps:
a. removing the liquid after the liquid has been homogeneously distributed on the liquid carrier surface, wherein a uniform layer of cell components are retained on the carrier surface;
b. drying the liquid carrier to retain the cell components uniformly positioned on the carrier surface; and
c. applying additional fluid or fluids to the liquid carrier upper surface after drying the liquid carrier, such as for fixation or staining purposes of the cell components retained thereon.

9. The method of claim 1, wherein the cell components suspended in the liquid comprise at least one subgroup which is to be detected.

10. The method of claim 1, wherein the liquid carrier is a microscope slide.

11. The method of claim 1, wherein the liquid carrier is circular.

12. The method of claim 11, wherein the area of the liquid carrier upper surface is at least 100 cm², between 100 cm² and 1000 cm², or the size of a CD or a record.

13. A device for the homogeneous distribution of cell components suspended in a liquid on a surface, the device comprising:
a. a table on which a liquid carrier can be positioned;
b. a liquid application device for applying a liquid onto a liquid carrier positioned on the table, wherein the liquid comprises cell components suspended therein;
c. a distributing bar spaced above and apart from the liquid carrier; and
d. a drive device capable of moving the table, the distributing bar or both individually or simultaneously, to move the liquid uniformly across the liquid carrier surface.

14. The device of claim 13, wherein a section of the distributing bar on which the liquid on the liquid carrier is in adhesion to the distributing bar is of a convex shape.

15. The device of claim 13, wherein the liquid carrier comprises one or more microscope slide(s).

16. The device of claim 13, wherein the liquid carrier is circular in cross-section.

17. The device of claim 13, wherein the distributing bar, the liquid carrier, or both have positioning elements for maintenance of a fixed distance from the liquid carrier surface during engagement of the drive device.

18. The device of claim 13, wherein the liquid application device comprises a central channel and one or more inlets or outlets in the distributing bar.

19. The device of claim 13, wherein the liquid application device is a pipette.

20. The device of claim 13, wherein the surface of the liquid carrier positioned on the table has an at least partly electrostatically charged surface or a coating of one or more antibodies and/or lipophilic molecules.
